(19) United States
(12) Patent Application Publication
(10) Pub. No.: US 2018/0020889 A1
(43) Pub. Date: Jan. 25, 2018

(54) Toilet With A Front Facing User-Accessible Compartment

(71) Applicants: David R. Hall, Provo, UT (US); Dan Allen, Springville, UT (US); Jared Reynolds, Pleasant Grove, UT (US); Ben Swenson, Lehi, UT (US); Joshua Larsen, Spanish Fork, UT (US); Cameron Price, Provo, UT (US); Eric Magleby, Provo, UT (US)

(72) Inventors: David R. Hall, Provo, UT (US); Dan Allen, Springville, UT (US); Jared Reynolds, Pleasant Grove, UT (US); Ben Swenson, Lehi, UT (US); Joshua Larsen, Spanish Fork, UT (US); Cameron Price, Provo, UT (US); Eric Magleby, Provo, UT (US)

(21) Appl. No.: 15/213,887

(22) Filed: Jul. 19, 2016

(51) Int. Cl. A47K 17/02; G01G 19/52; A47L 11/40; E03D 11/13

(52) U.S. Cl. CPC A47K 17/02; E03D 11/13; G01G 19/52; A47L 11/4091; A47K 17/028; A61H 35/006

(57) ABSTRACT

A toilet with a base portion containing a front facing user-accessible compartment is disclosed. A channel is provided within a base portion for connecting a floor sewer pipe to the raised base of the toilet. Multiple embodiments are disclosed in which the user-accessible front facing user-accessible compartment comprises a retractable foot spa, a retractable scale, a computer processor, and user health devices. User interfaces are disclosed for the operation of the front facing user-accessible compartment and other functions of the front facing user-accessible compartment. Latching and moving mechanisms are also disclosed and claimed herein.

### BACKGROUND

### Field of the Invention

The present invention relates to the elevation of flush toilets by means of a front facing user-accessible compartment that is installed for increased convenience of a user.

### Background of the Invention

Toilets are hard for people with reduced mobility to sit on and stand up from. Several solutions have been implemented to address this problem. Two general solutions include increasing the height of the toilet so the user does not have to bend as far, and motorizing a lift to push users up to a standing position. “Comfort height” toilets exist that are a few inches higher than normal toilets. Others offer extra thick/tall toilet seats, removable cushions or other height increasing objects which go on top of the toilet bowl. Handicap bathrooms include handles on the wall for using hands to support the body while sitting and standing. Existing inventions in this field fall short in the sense that they are inefficient at using added space that comes with a higher toilet seat. In addition, increasing the distance between a user and a toilet reservoir may cause a user discomfort by causing unwanted splashing upon depositing waste. What is needed is a way to make a particular toilet and seat more easy to use for persons with reduced mobility.

### SUMMARY

This invention has been developed in response to the present state of the art and, in particular, in response to the problems and needs in the art that have not yet been fully solved by currently available systems and methods. Accordingly, an improved toilet has been developed. Features and advantages of different embodiments of the invention will become more fully apparent from the following description and appended claims, or may be learned by practice of the invention as set forth hereinafter.

Consistent with the foregoing, a toilet having a front facing user-accessible compartment is disclosed. In one embodiment the compartment comprises a foot spa. In another embodiment the compartment comprises a retractable front facing user-accessible compartment. In other embodiments the compartment comprises a retractable scale, medical devices, computer processors, or user interfaces. A toilet with the front facing user-accessible locking compartment mechanism to protect a user's storage security is disclosed. Wireless communication devices are disclosed, which allow the transfer of medical or other measured data. A water supply line for filling the foot spa, as well as a drain channel that allows the draining of said foot spa are also disclosed and claimed herein.

### BRIEF DESCRIPTION OF THE DRAWINGS

In order that the advantages of the invention will be readily understood, a more particular description of the invention briefly described above will be rendered by reference to specific embodiments illustrated in the appended drawings. Understanding that these drawings depict only typical embodiments of the invention and are not therefore to be considered limiting of its scope, the invention will be described and explained with additional specificity and detail through use of the accompanying drawings, in which:

FIG. 1 shows a top-down view of a toilet utilizing an embodiment of the present invention;

FIG. 2 shows a top-down view of a toilet utilizing an embodiment of the present invention;

FIG. 3 is a cross-sectional view of a toilet utilizing an embodiment of the present invention;

FIG. 4 is a side view showing a toilet utilizing an embodiment of the present invention;

FIG. 5 is a top-down view of a toilet utilizing an embodiment of the present invention;

FIG. 6 is a side view of a toilet utilizing an embodiment of the present invention;

FIG. 7 is a side view of a toilet utilizing an embodiment of the present invention;

FIG. 8 is a side view of a toilet utilizing an embodiment of the present invention;

FIG. 9 is a side view of a toilet utilizing an embodiment of the present invention; and

FIG. 10 is a frontal view of a toilet utilizing an embodiment of the present invention.

### DETAILED DESCRIPTION

It will be readily understood that the components of the present invention, as generally described and illustrated in the Figures herein, could be arranged and designed in a wide variety of different configurations. Thus, the following more detailed description of the embodiments of the invention, as represented in the Figures, is not intended to limit the scope of the invention, as claimed, but is merely representative of certain examples of presently contemplated embodiments in accordance with the invention. The presently described embodiments will be best understood by reference to the drawings, wherein like parts are designated by like numerals throughout.

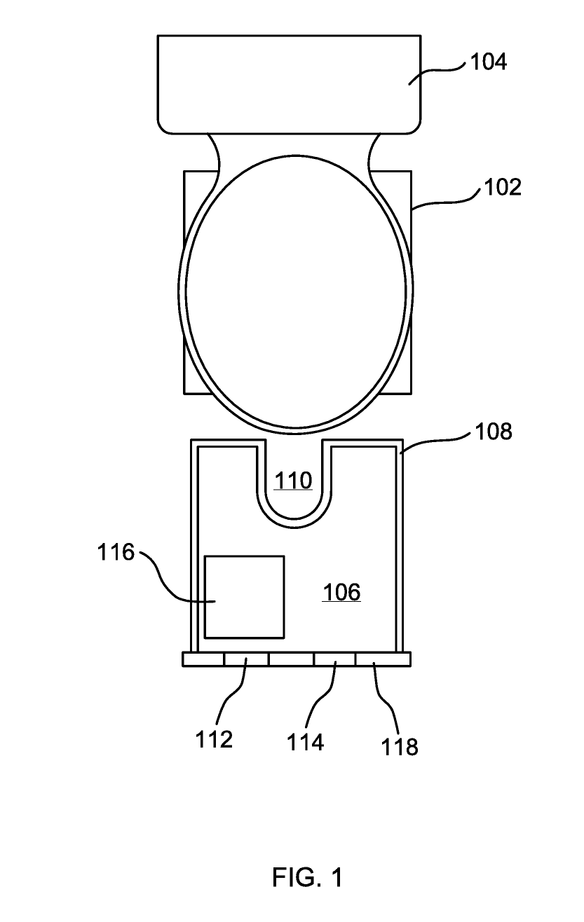

Referring to FIG. 1, a top-down view of a toilet 104 being raised by a base portion 102 is shown. The base portion 102 may contain a front facing user-accessible compartment 106. The front facing user-accessible compartment 106 shown has a compartment enclosure 108 which stores and protects items 116 contained in the front facing user-accessible compartment 106. The front facing user-accessible compartment may open toward a toilet user's feet while the toilet user is using the toilet. The items 116 may comprise toiletries, feminine hygiene products, or cleaning products. The items 116 may also comprise a computer processor for operating electronics housed within the toilet 104 or base portion 102. The items 116 may also comprise storage vessels containing cleaning, disinfecting, or deodorizing products for use in a toilet seat or bidet rinsing system. The front facing user-accessible compartment 106 may also be used to store towels, emergency equipment, electronic devices, medications, clothes, or valuables, all of which may be securely locked in the front facing user-accessible compartment 106 in a manner described hereafter. The front facing user-accessible compartment 106 comprises a channel cavity 110 through which an outlet pipe of the toilet 104 may pass. The front facing user-accessible compartment 106 further comprises a frontal panel 118 attached to the compartment enclosure 108, said frontal panel 118 comprising a first user interface 112, and a second user interface 114. The user interfaces 112, 114 may comprise handles, buttons, clasps, levers, straps, or other manual means by which a user may open or close the front facing user-accessible compartment 106. The user interfaces 112, 114, may also comprise digital interfaces such as a keypad or biometric apparatus, allowing a user to more securely store items in the front facing user-accessible compartment 106. The base portion 102 may be integrally formed out of the same material as the toilet bowl or may be an additional section of the toilet removable from a bowl section of the toilet.

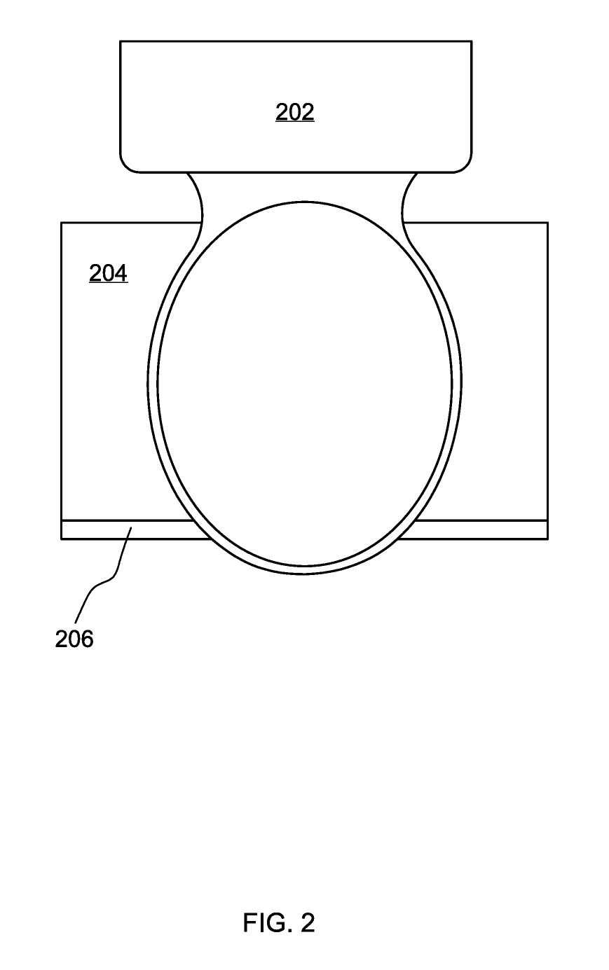

FIG. 2 shows a top-down view of a toilet 202 being raised by a base portion 204. A front facing user-accessible compartment 206, similar to the front facing user-accessible compartment 106 described in FIG. 1, is in the closed position. The front facing user-accessible compartment may open toward a toilet user's feet while the toilet user is using the toilet. Here the base portion 204 is shown as larger than a standard base section of a toilet. The base portion 204 may be the same size as the base of a standard toilet or be larger. The base portion 204 may be integrally formed out of the same material as the rest of the toilet to form one continuous material or may be a separate toilet component which may be removable from the other portions of the toilet. The wide base portion 204 shown in FIG. 2, may be used as a squatting stool allowing toilet users to stand or squat directly over toilet 202 while using toilet 202.

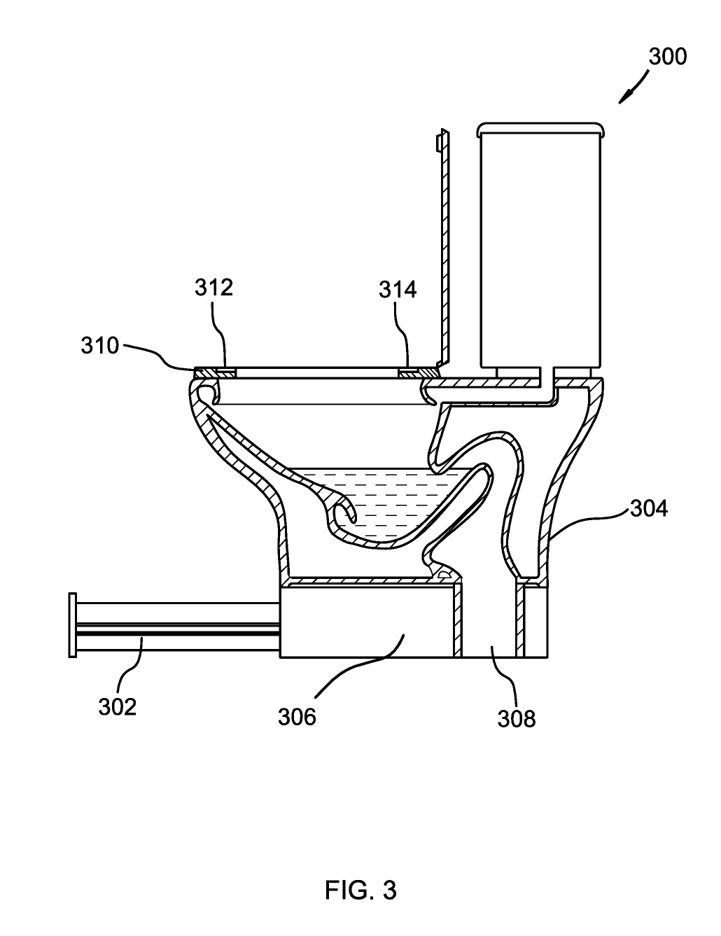

FIG. 3 shows a cross-sectional view of a toilet 300 being raised by a base portion 306. Base portion 306 may have a height of 1 to 12 inches measured vertically between the floor and the toilet bowl. The base portion 306 further comprising a retractable drawer 302 and a channel 308 for connecting the outlet of toilet 300 to an external sewage line so that the operation of the toilet is not impeded by the use of the base portion 306. The toilet structure 304 may rest upon the base portion 306 by gravitational force or by means of mechanical attachment. Alternatively, the toilet structure 304 may be integrally formed with walls of base portion 306. Sensors 312, 314 are shown integrated in the toilet seat 310 for purposes that may include user identification and health monitoring. Health monitoring may include the measurement of body composition by means of bio-impedance sensors or user weight by means of pressure transducers.

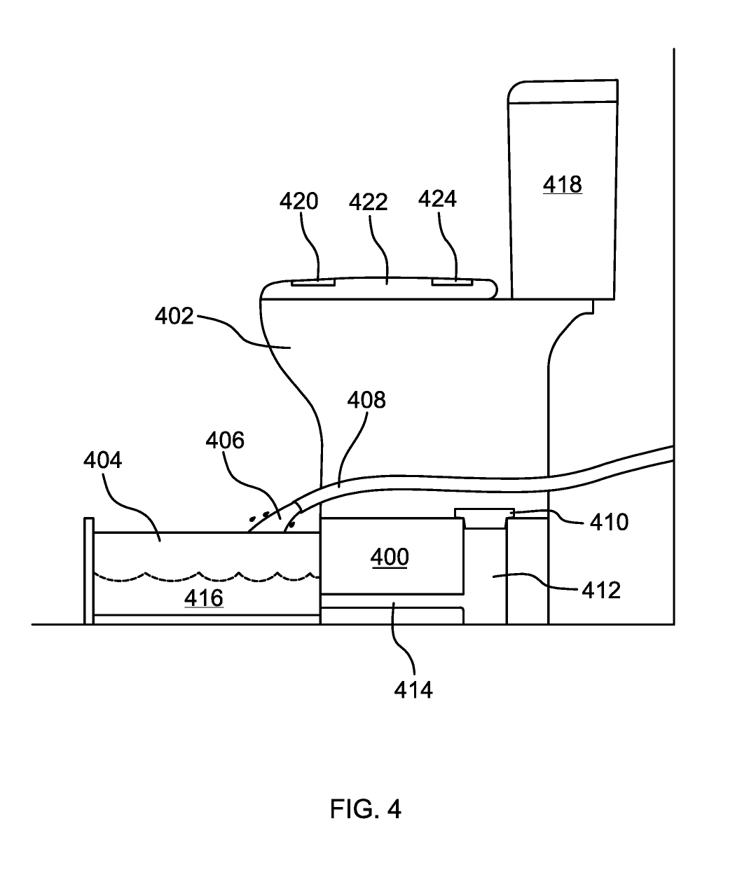

FIG. 4 shows a side view of a toilet 418 being raised by a base portion 400. Base portion 400 comprises a retractable front facing user-accessible compartment 416 that may be used as a foot spa. Front facing user-accessible compartment 416 may be filled with water 406 that is transferred by a water supply line 408 that is attached to a pressurized utility line. The water supply line 408 may comprise a user accessible spigot. The water 406 that fills the front facing user-accessible compartment 416 is contained on the sides by a storage enclosure 404. The front facing user-accessible compartment 416 may be drained through an auxiliary one-way drain line 414 that connects to a channel 412. A sewer pipe extension 410 is housed by the channel 412. The sewer pipe extension 410 will allow the passage of the contents of the toilet bowl 402 from the outlet of the toilet 418 to a sewer pipe in the floor. User interfaces 420, 424 are shown integrated in the toilet lid 422 for purposes that may include programming, scheduling, or adjusting functions of the base portion 400. User interfaces 420, 424 may also display data recorded by the sensors of the toilet 418 and/or base portion 400. Such data may include water levels and flow, water quality analysis, water temperature, input from biometric sensors, or input from wirelessly tethered devices.

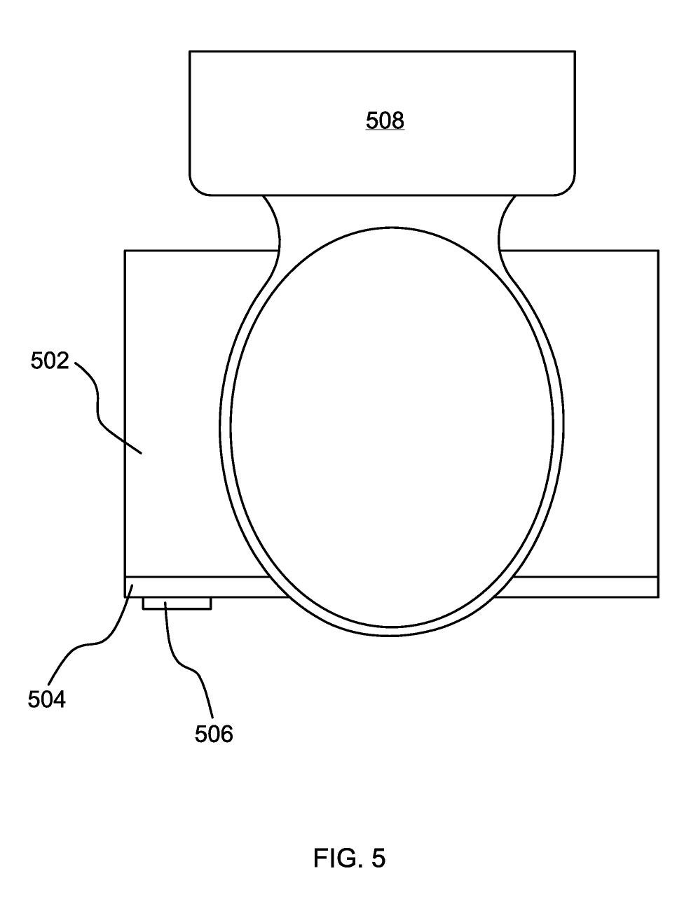

FIG. 5 shows a top-down view of a toilet 508 being raised by a base portion 502. A user-accessible front facing user-accessible compartment 504 is in the closed position and can be opened by the latch 506. The latch 506 may comprise a strap, clip, sensor, or clasp that may be easily accessible by a user's foot. The wide base portion 502 may be used as a squatting stool allowing toilet users to stand or squat directly over toilet 508 while using toilet 508.

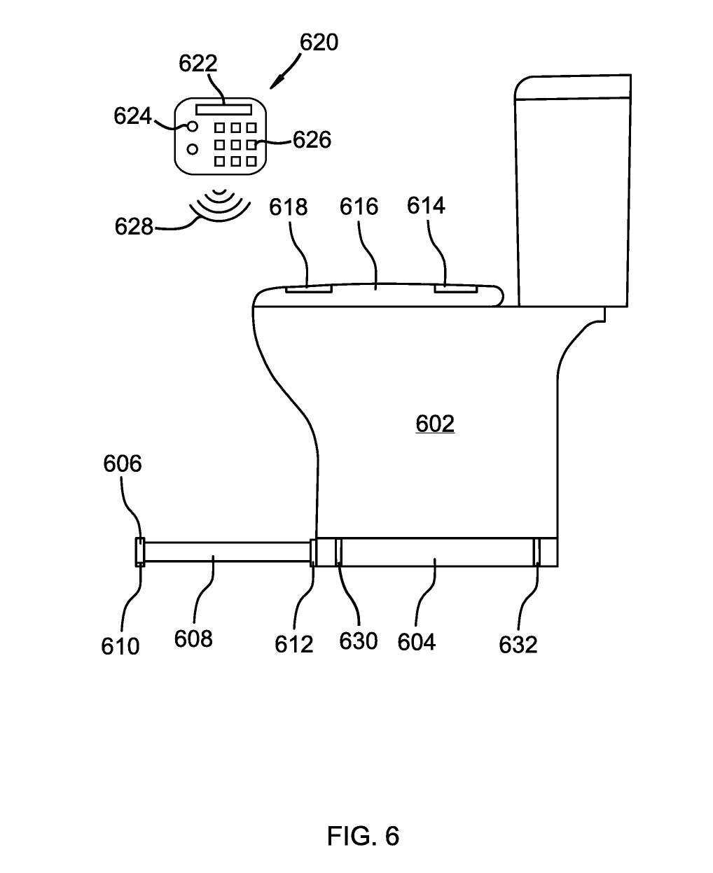

FIG. 6 shows a toilet 602 being raised by a base portion 604. Base portion 604 houses a retractable scale 608 that derives measurements from force sensors 606, 612 and is easily mobilized by a roller 610. The roller 610 may comprise a motorized component that may be controlled by user input that may come from a wall-mounted user interface 620 or from a wirelessly connected user device such as a mobile telephone, laptop, or tablet. Base portion 604 is attached to the floor and the base of toilet 602 by means of fixture openings 630, 632 through which bolts, screws, or other attachment mechanisms may be placed in order to rigidly fix the toilet 602 and the base portion 604 to the floor. Base portion 604 may also house the processors and hard drive for the wall-mounted user interface 620. The wall-mounted user interface 620 may comprise an electronic screen 622, physical buttons 626, biometric sensors 624, and wireless capability 628. The wall-mounted user interface 620 may be used to control toilet functions or view input from sensors within toilet 602 and/or base portion 604. The wall-mounted user interface 620 may also be used to wirelessly control a household thermostat, view household security footage, turn on electronic appliances in the home that may include the televisions, speakers, or ovens. The wall-mounted user interface 620 may also have the ability to connect to the internet and securely upload data that has been recorded by the sensors of the base portion 604.

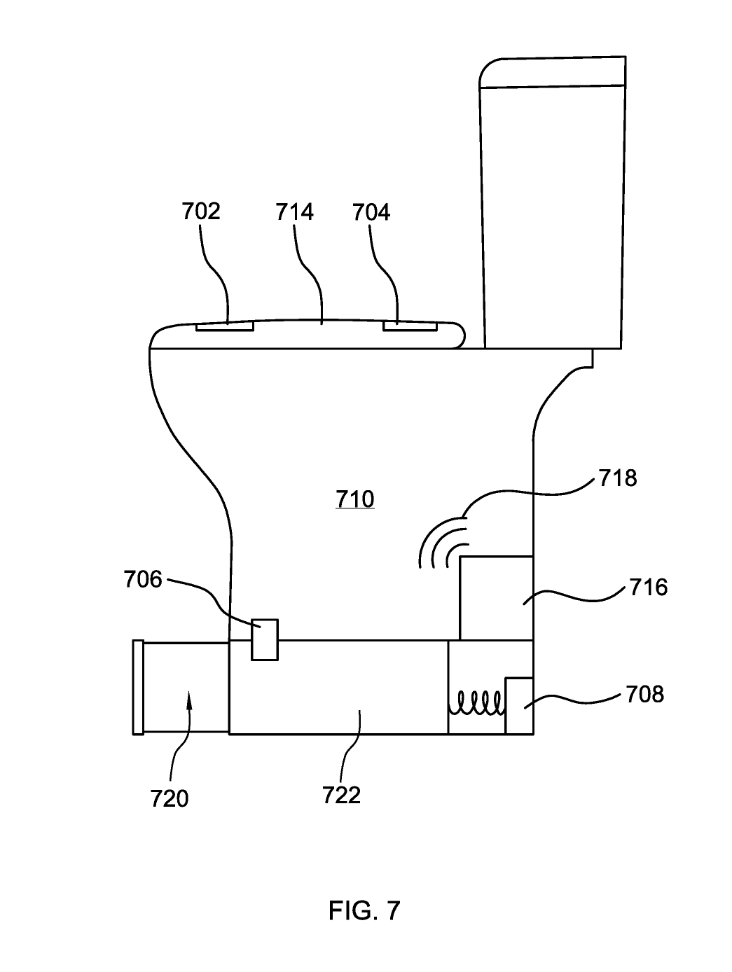

FIG. 7 shows a side view of a toilet 710 being raised by a base portion 722. A front facing user-accessible compartment 720 may be moved mechanically into the open position by a spring 708. The front facing user-accessible compartment 720 may comprise a medical device such as blood pressure cuff. Alternatively, the spring 708 may be a piston or other electronically operated mechanical device. A user interface 706 may be used to operate the spring 708. Sensors 702, 704 on the toilet seat 714 may be used for user identification or for data collection related to user health needs. A computer processor 716 may conduct computations for the sensors 702, 704 by a wireless data transfer 718. Alternatively, the computer processer 716 may wirelessly operate the spring 708.

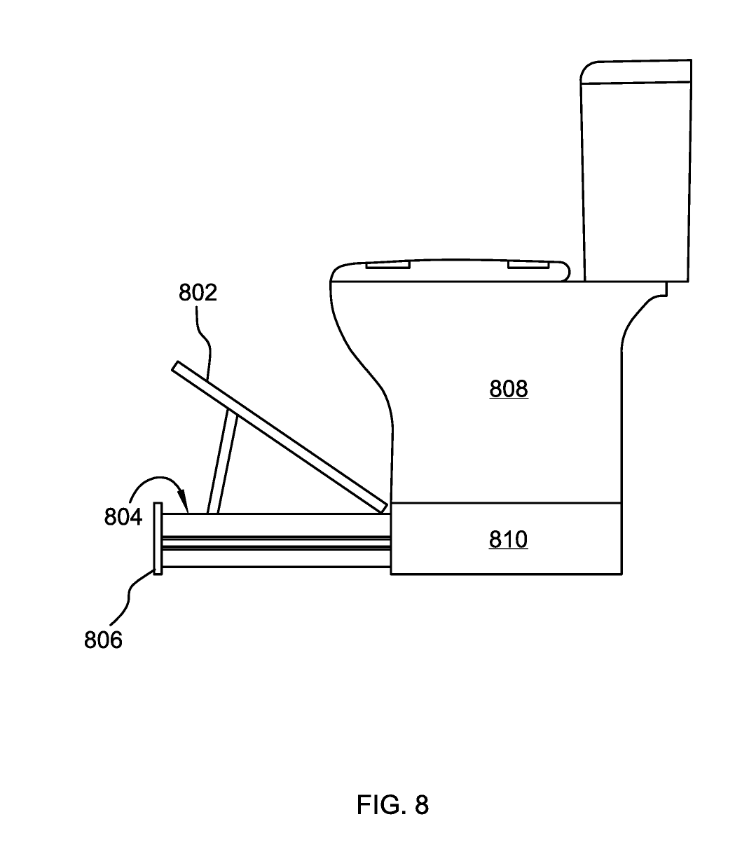

FIG. 8 shows a side view of a toilet 808 being raised by a base portion 810. The base portion 810 is shown housing a retractable drawer 804 that houses a retractable footstool 802. When the retractable drawer 804 is in the open position a footstool support 812 may elevate the footstool 802 in a sloped position or the footstool support 812 may elevate the footstool 802 while maintain a slope parallel to the floor. The footstool 802 may allow users with shorter legs to lift their knees to a better posture for defecation, or to function as a stool for children, or simply to allow users to experience the toilet at the normal height. When the retractable drawer 804 is in the closed position, the retractable footstool is concealed by a front panel 806. The retractable drawer 804 and the retractable footstool 802 may be electronically operable by motorized means such that a user would need to manually operate the retractable footstool 802.

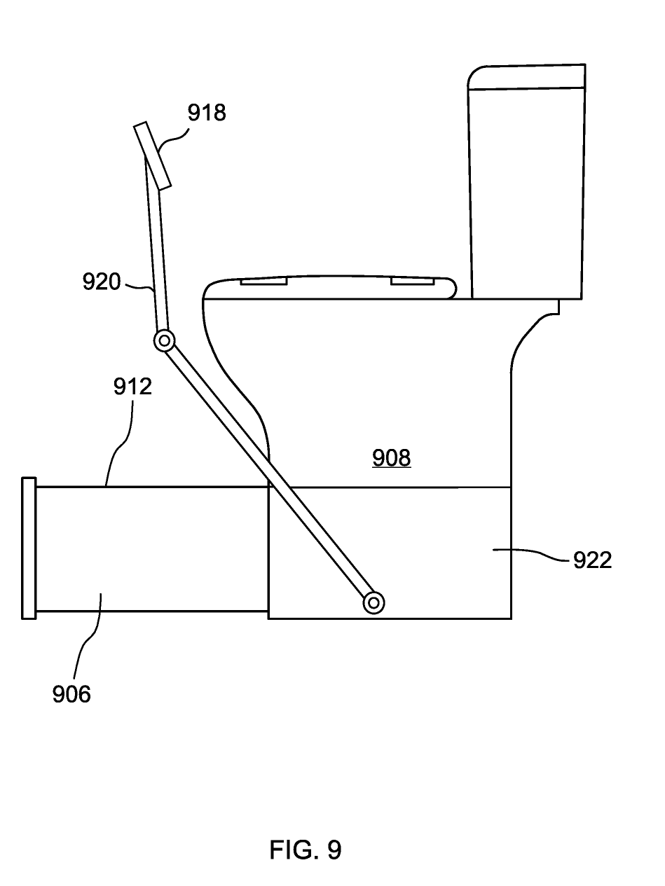

FIG. 9 shows a side view of a toilet 908 that is being raised by base portion 922. Base portion 922 houses a front facing user-accessible compartment 912 enclosed on at least two sides by front facing user-accessible compartment housings 906. A user interface 918 mounted on a retractable arm 920 may be used to open, close, or lock the front facing user-accessible compartment 912. The retractable arm 920 may be mounted to the side of the base portion 922 by means of mechanical attachment. The retractable arm 920 may be electronically operable by motorized means such that a user would not need to manually operate the retractable arm 920. The user interface 918 may comprise the appearance and functionality of the wall-mounted user interface 620 of FIG. 6.

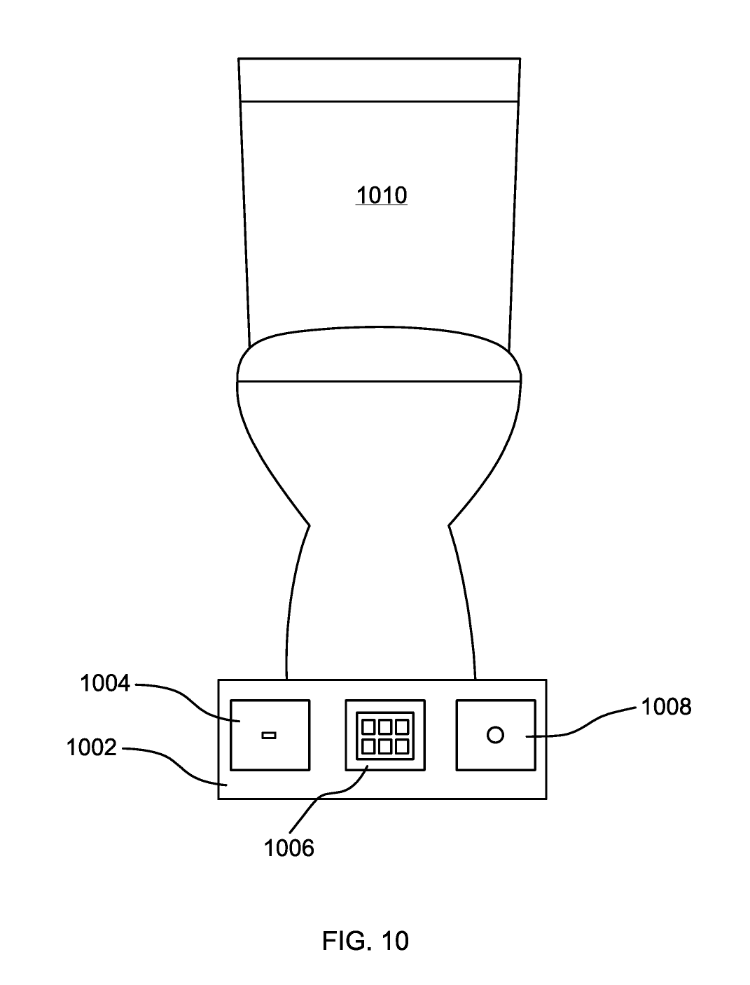

FIG. 10 shows a frontal view of a toilet 1010 being raised on a base portion 1002. The base portion 1002 comprises electrical systems comprising one or more of a battery, an inverter, an electrical receptacle, a wireless communication device, or a processor. The base portion 1002 may also house electronic components that may include a USB port 1004 for charging electronic devices or reading USB devices. The USB port may be recessed in the front of the base section 1002 allowing a robotic vacuum to dock and charge within the user-accessible compartment. The base portion 1002 may also house a compartment 1008 that may comprise an inverter and/or a backup battery that may be charged from external sources and used to power electronic systems within or connected to the base portion 1002. The front facing user-accessible compartment may also comprise a user interface 1006 to operate any or all electrical and/or mechanical systems housed within the base portion 1002 or the toilet 1010.

The systems and methods disclosed herein may be embodied in other specific forms without departing from their spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A toilet comprising:
a base portion which supports a bowl of the toilet, the base portion positioned between the toilet bowl and a floor;
a front facing user-accessible compartment located in the base portion, the front facing user-accessible compartment opening toward a toilet user's feet while the toilet user is using the toilet and comprising a channel cavity through which an outlet pipe of the toilet passes;
wherein the front facing user-accessible compartment is accessed by a drawer, and
wherein the front facing user-accessible compartment has a height, measured vertically between the floor and the toilet bowl, of between one to twelve inches.

2. The toilet of claim 1, wherein the base portion is integrally formed with a material of the toilet bowl.

3. The toilet of claim 1, wherein the base portion is not integrally formed with a material of the toilet bowl.

4. The toilet of claim 1, wherein a sewer pipe extends through the front facing user-accessible compartment and passes through the channel cavity.

5.-19. (canceled)

20. The toilet of claim 1, wherein a toilet computer is stored within the base portion of the toilet.
